(19) United States
(12) Patent Application Publication
(10) Pub. No.: US 2023/0168789 A1
(43) Pub. Date: Jun. 1, 2023

(54) PROXIMAL GEOGRAPHIC ORIENTAL ASSOCIATIVE IDENTITY

(71) Applicant: Drew Ronald Dominique Cloutier, Standish, ME (US)

(72) Inventor: Drew Ronald Dominique Cloutier, Standish, ME (US)

(21) Appl. No.: 17/456,634

(22) Filed: Nov. 27, 2021

(51) Int. Cl. G06F 3/04817; G06F 3/04886; G06F 3/04842; G01S 19/24

(52) U.S. Cl. CPC G06F 3/04817; G06F 3/04886; G06F 3/04842; G01S 19/243

(57) ABSTRACT

An electronic device includes a global positioning system (GPS) processor to establish locality and a GPS capture controller to isolate a pre-defined personalized proximal network with axial cardinal orientation. A display presents the proximal network of co-inhabitants at interface, and a touch-controller allows for the haptic contact selection of alternate user icon(s) to execute telecommunication between distinguishable users within the proximal field through associative geographic identity.

### FIELD OF THE INVENTION

This invention relates to proximal interactions through electronic actions, such as the exchange of text, audio, video, currency, imagery and directed accommodations like that of vendor services. More specifically, this invention relates to a proximal network in a global positioning system with cardinal orientation, that alternately provides a venue for telecommunication via oriental associative identity through the utilization of the GPS capture controller functionality.

### BACKGROUND OF THE INVENTION

Current methods of telecommunication require that a user obtain prior routing in transmission of digital media. Problematically, this is void of unidirectional user selection through the proximal field of inhabitance of pooled users. Moreover, venues that facilitate telecommunication maintain algorithms, and require knowledge or acquisition of routing, resulting in missed connections in present space and time. Psychological inhibition for the execution of unidirectional interpersonal communication in an era of technological adaptation and reliance, are to be overcome; eliminating the digital, physical, and mental barriers in proximal communication that are inspired by sight in real space and time.

### SUMMARY OF THE INVENTION

A device and method for facilitating the exchange of text, imagery, and audio, comprising: a computing device comprising a processor unit; an imaging device; a speaker; a microphone; a GPS processor; and a display, wherein the processor unit is programmed to perform actions comprising: displaying at the display a unimodal launch icon, wherein the launch icon is alternately selectable by a user of the computing device in a first mode and in a second mode; detecting a first user input that selects the launch icon in the first mode; in response to the first user input, executing a first application at the computing device; receiving and displaying, from the GPS processor, a network environment of selectable launch icon(s) of same operating application and running on a global positioning system, limited by proximity defined by standardized circumference around the interfaced computing device with axial cardinal orientation; detecting a second user input that selects a launch icon from the network environment of alternate user(s); in response to the second user input, prompting the user to execute the transmission of digital communication.

### BRIEF DESCRIPTION OF THE FIGURES

The invention concept is articulated in the section, “Detailed Description of the Inventions,” and illustrated in the accompanying drawings, in which:

FIG. 1—illustrates components of an electronic device necessary to execute the method of telecommunication.

FIG. 2—illustrates processing operations associated with an embodiment of the invention.

FIG. 3—illustrates the exterior of the electronic device (e.g. smartphone, watch, motor vehicle display, etc.), to display the embodiment of the invention for multiple users in respective geographical network boundaries.

FIG. 4—illustrates the exterior of the electronic device, with operations associated in the embodiment of the invention at single user interface within their respective geographical boundary.

Referenced numerals associate to corresponding parts throughout the figures to better articulate perception in the section, “Detailed Description of the Invention.”

### DETAILED DESCRIPTION OF THE INVENTION

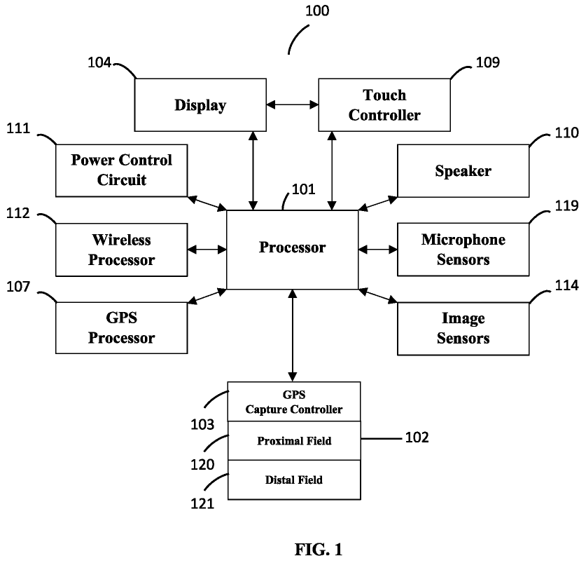

FIG. 1 illustrates an electronic device 100 detailing the interaction between different components of the hardware, to facilitate the operating methods of the invention. In one embodiment, the electronic device 100 resembles a smartphone with a processor 101 in communication with a memory 102. The memory 102 is both a random-access memory and a flash memory. The memory 102 maintains a GPS capture controller 103 to facilitate operations of the invention and execute instructions to delineate a proximal crowd of user(s) that populate on a display 104. The electronic device(s) of alternate user(s) populates on the display 104 as unimodal launch icon(s) 105 around the interfaced electronic device 100; in a geographically coordinated manner facilitated by axial cardinal orientation respective to the presentation of the interfaced electronic device's 100 beacon 106, as described below.

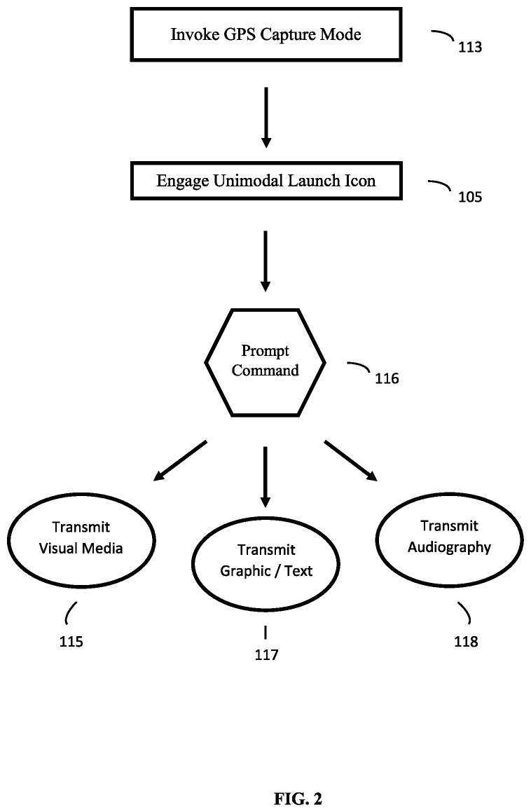

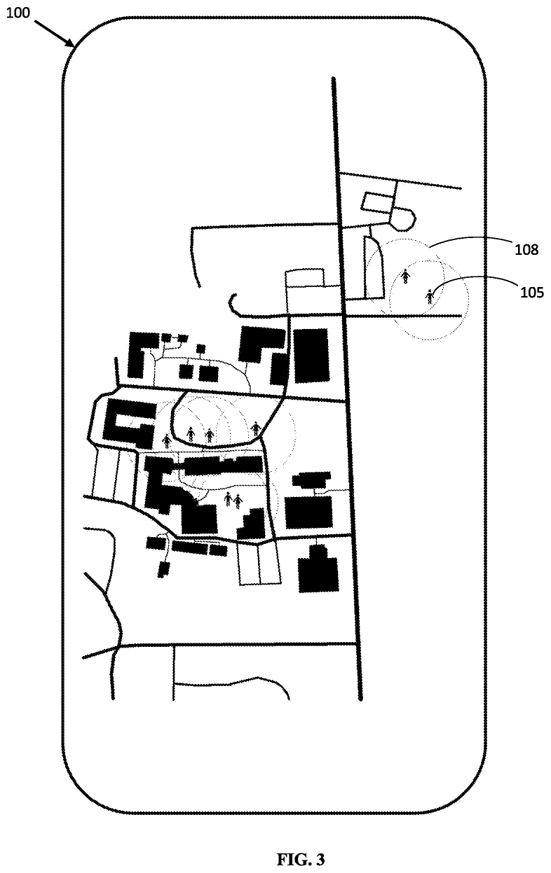

The GPS capture controller 103 functions with the interaction of a processor 101, to reference global positioning data of core users. The GPS capture controller 103 isolates coordinates transmitted by the GPS processor 107, within a parametric boundary 108 around the electronic device 100, further articulated in the discussion of FIG. 3. Alternately, the proximal coordinates segregated by the GPS capture controller 103 transmit to the display as unimodal launch icon(s) 105. A touch controller 109 is connected to the display 104 and a processor 101. The touch controller 109 is responsive to haptic signals applied to the display 104. In one embodiment, the GPS capture controller 103 presents unimodal launch icon(s) 105 on the display 104 with instructions executed by the processor 101. The touch controller 109 is responsive to haptic signals applied to the display 104 and allows for the selection of unimodal launch icon(s) present on the display 104, as detailed in the discussion of FIG. 2.

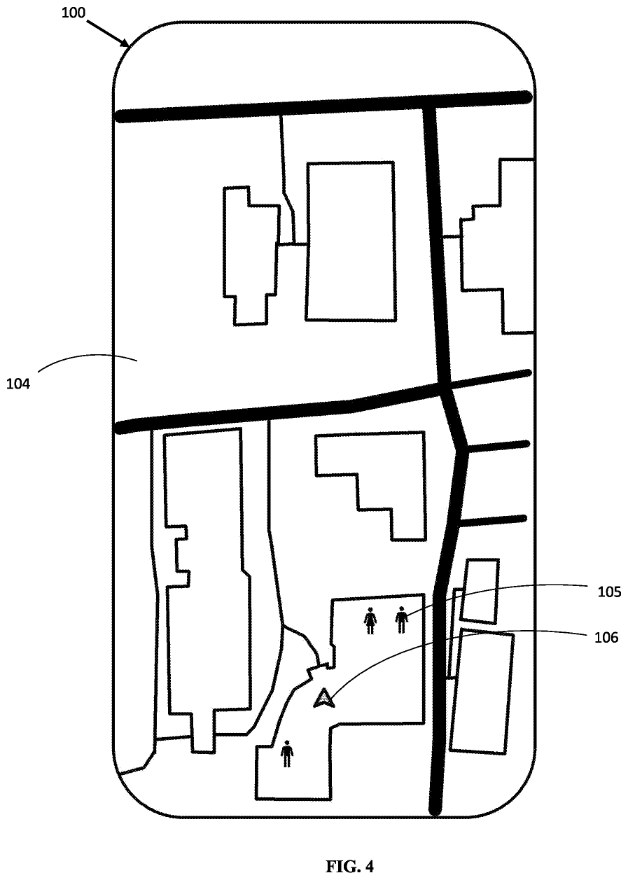

A speaker 110, power control circuit 111, and wireless processor 112 are integrated hardware of the electronic device 100. The electronic device 100 maintains components common among technological innovations but is undistinguishable with respect to the functionality of the GPS capture controller 103. FIG. 2 illustrates processing operations associated with the GPS capture controller 103. Initially, a GPS capture mode is invoked 113. This functionality allows for the user to engage the unimodal launch icon(s) 105 presented on the display 104; directed communicative selection may be determined with precision through associative identity with respect to axial positioning of the beacon 106 representing the electronic device 100 on the display 104 in real space and time. The processor 101 may also be coupled to image sensors 114 on the electronic device 100 which allow for the capture and transmission of visual media 115 through prompt commands 116; alternately, processing directions may allow for the retrieval and transmission of data from photo and video libraries within the memory 102. In conjunction with the exchange of visual media, transmission of text or graphic media 117 and audio media 118 facilitated between the interplay of the processor 101 and the microphone sensors 119 or the memory 102, may further aid in communication. In one embodiment, the aforementioned telecommunicative instruments, are manipulated at user interface of the display 104 via haptic selection, to achieve transmission of perceptive sensory data between user(s) associated with unimodal launch icon(s) 105 coordinated by the functionality of the GPS capture controller 103, as detailed in the discussion of FIG. 4.

FIG. 3 is a representation of concept for core users and the co-inhabitants of each respective unimodal launch icon 105 occupying the parametric boundary 108 illustrated on the display 104. The parametric boundary is a computational zone of user inclusion and exclusion, set by a preconfigured radii about the electronic device (e.g. 100 meters), as proximal 120 and distal 121 field inhabitants, respectfully. FIG. 4 depicts one embodiment, at user interface, in which geographic axial cardinal orientation of the electronic device 100 is represented on the display 104 as a beacon 106. Alternate user(s) are presented as unimodal launch icon(s) 105 and choreographed with respect to orientation about the user beacon 106 via the functionality of the GPS capture controllers 103 proximal field 120 inclusion criteria. Distal field exclusion criteria (e.g. >100 meters) eliminates visibility of unimodal launch icon(s) 105 on display 104. In a subsequent embodiment, the haptic selection of a unimodal launch icon 105 diverges to prompt commands 116 for user selection and transmission of perceptive sensory data between users: for example, to achieve transmission of photography, audiography and graphic or text media. Further, other embodiments may allow for the exchange of currency, vendor services and electronically mediated introductions. Thus, at user interface, interpersonal acquaintances may be made electronically through real space and time, with the assistance of geographical axial cardinal orientation, unimodal launch icon associative identity selection and haptic engagement; made possible by the GPS capture controller. Alternately, the executive operating functionality of a populated unimodal launch icon 105 or user beacon 106 may allow for the transmission of communicative avenues encompassing all forms of digital media, preserved for reference in present or future time, and may be expanded upon to generate a social profile.

An embodiment of the invention relates to a computer memory unit, storing computational processing commands to achieve various computer executed operations, through manipulation of the media. The method illustrated in the present invention may be coded in many fashions for those having skill in the computer software arts. Examples of machine-readable media include magnetic and optical media as well, as hardware devices that serve as a platform to execute program code. For example, the invention is not restrained to the platform, nor the language of the embodiment, but may be utilized through various coding languages to pass perception and provide practical applicability to the invention, as envisioned.

What is claimed:

1. An electronic device, comprising: GPS processor to transmit and receive geographic data elements; a GPS capture controller to orientate geographic data received on a continuum, within a defined parameter about the device; a display to present the geographic data as unimodal launch icon(s) for respective data element(s); a touch controller to identify haptic contact engagement of alternately selectable unimodal launch icon(s).

2. The electronic device of claim 1 wherein the GPS capture controller selectively stores authorized geographic data.

3. The electronic device of claim 2 wherein the GPS capture controller invokes a presentation of a parametrically defined proximal selection of oriental geographic data element(s) as unimodal launch icon(s) on the display.

4. The electronic device of claim 3 wherein the unimodal launch icon(s) on display are alternately selectable via haptic contact, sensitive to a touch controller.

5. The electronic device of claim 1 wherein the GPS capture controller includes instructions executed by a processor.

6. The electronic device of claim 5 further comprising a wireless signal processor and a power control circuit.

7. A non-transient computer readable storage medium, comprising automated instructions to process geographic data element(s); present on display, selective data element(s) as unimodal launch icon(s) based upon a parametric boundary for data element inclusion, set by a preconfigured radii about the electronic device and exclude presentation of data elements outside of the preconfigured radii, for which automation is maintained on a continuum.

8. The non-transient computer readable storage medium of claim 7 wherein geographic data element(s) are transmitted by the GPS processor; and the geographic data is delineated for display by the GPS capture controller.
